(19) United States
(12) Patent Application Publication
(10) Pub. No.: US 2026/0305631 A1
(43) Pub. Date: Oct. 8, 2026

(54) PROCESS FOR STABILISING A MACERATED OIL

(71) Applicant: LINNEA SA, Riazzino (Locarno) (CH)

(72) Inventors: Umberto CIRIELLO, Giubiasco (TI) (CH); Giuseppe PALADINO, Seseglio (TI) (CH)

(73) Assignee: LINNEA SA, Riazzino (Locarno) (CH)

(21) Appl. No.: 19/155,054

(22) PCT Filed: Dec. 13, 2024
(86) PCT No.: PCT/EP2024/086295

§ 371 Date: Aug. 8, 2025

(30) Foreign Application Priority Data
Dec. 28, 2023 (CH) CH001501/2023
Dec. 28, 2023 (IT) 102023000028233

(51) Int. Cl. A23B 20/30

(52) U.S. Cl. CPC A23B 20/30

(57) ABSTRACT

A process for stabilizing a macerated oil, the macerated oil including a liquid carrier and a compound soluble in said liquid carrier, the compound containing at least one cannabinoid. The process removes oxygen from the liquid carrier before, during or after the dissolution of the soluble compound. The process includes a step of introducing the liquid carrier into a containment device and, subsequently, removing oxygen by creating a vacuum lower than 400 mbar inside the containment device until the oxygen present both in the containment device and inside the liquid carrier is removed.

### CROSS-REFERENCE TO RELATED APPLICATIONS

The present application is a U.S. National Phase Application under 35 U.S.C. § 371 of International PCT/EP2024/086295 filed Dec. 13, 2024, which claims priority of Italian Patent Application No. 102023000028233 filed Dec. 28, 2023, and Swiss Patent Application No. 001501/2023 filed Dec. 28, 2023. The entire contents of which are hereby incorporated by reference.

### FIELD OF THE INVENTION

The present invention relates to a process for stabilizing a macerated oil comprising a liquid carrier and a compound soluble in said carrier and containing at least one cannabinoid.

### BACKGROUND

Cannabidiol (CBD) is a cannabinoid, a terpenophenolic compound with multiple therapeutic potentialities and devoid of psychotropic activity. Thanks to its considerable therapeutic potential and good safety profile, associated with the absence of mind-altering activity, cannabidiol has for years been the subject of numerous studies aimed at delineating its mechanism of action and its interaction with the human endocannabinoid system.

The human endocannabinoid system was discovered following the identification of endocannabinoid receptors. At present, the two main receptors belonging to the endocannabinoid system are represented by the CB1 and CB2 families and they are capable of interacting with various endogenous ligands, generically called endocannabinoids. The endocannabinoid system is an ancestral, ubiquitous system of homeostatic regulation, capable of finely modulating vital functions such as hunger, sleep and the responses to various types of stress: CB1 and CB2 receptors are thus disseminated throughout all regions of the body, with a prevalence of CB1 receptors in the central nervous system, in particular in the areas responsible for motor control, emotional and behavioral responses and energy management. CB2 receptors, by contrast, are more concentrated in the immune system. As the regulation of homeostasis is vital for an individual's survival, the human body exerts a fine control over the endocannabinoid system through the action of enzymes of the FAAH (fatty acid amide hydrolase) family, which have the role of regulating the levels of endocannabinoids in the human body.

The therapeutic effects of cannabidiol are primarily ascribable to its interaction with the human endocannabinoid system: there exists evidence that cannabidiol is capable of allosterically modulating CB1 and CB2 receptors and of binding with fatty acid amide hydrolases (FAAH), thereby modulating the endocannabinoid levels. Furthermore, cannabidiol interacts with the voltage-dependent channels of TRPV family, responsible for the sensation of pain, and with many other ligands, present in the serotonergic system, GABAergic, and others.

Cannabidiol (CBD) is presently authorized as a drug for accessory treatment of some forms of drug-resistant epilepsy and is used in off-label extemporaneous preparations for the treatment of some psychotic disorders, anxiety, depression, insomnia, diabetes, cardiovascular disorders and chronic pain in various countries in the world. Of great interest are the numerous studies that ascribe to CBD an antiblastic activity towards many forms of cancer.

In order to further pursue research on this promising molecule, it is necessary that the dosage forms through which the administration of cannabinoids takes place are stable and do not undergo phenomena of degradation and alteration over time.

Cannabidiol (CBD) is a cannabinoid that can be extracted from Cannabis sativa L., or it can be obtained by synthesis, semi-synthesis or fermentation and it can be dissolved in vegetable oils to obtain solutions with a known CBD concentration. For the preparation of such solutions, it is possible to start from pure CBD or from Cannabis sativa extracts containing this cannabinoid. The oils that are generally used for the preparation of such macerated oils are: olive oil, maize oil, sesame oil and, in general, all commercially available vegetable oils. A preferable oil for this type of preparations is oil obtained from medium-chain triglycerides (MCTs), which is very stable towards oxidation and is thus unlikely to turn rancid and is for this reason an ideal carrier for the preparation of cannabinoid solutions, also pharmaceutical grade.

Pure CBD appears as a white or whitish crystal which, if stored under proper conditions, is well known to be stable for several years in all the climate zones envisaged by ICH QIA (R2) guidelines, “Stability testing of New Drug Substances and Products”. In contrast, under equal storage conditions, the solutions thereof in oil show a rather rapid degradation with the formation of oxidation impurities in the presence of oxygen, catalyzed by exposure to light and heat. One of the best-known degradation products which form during the processes of oxidation of CBD solutions in oil is cannabidiol hydroxyquinone (CBD-HQ), also known as HU-331. This substance has a very intense orange color (the oxidation impurities of CBD are generally colored), easily recognizable in CBD solutions, which start off being glassy and clear, and to which it imparts a color from yellow to red, in proportion to the concentration of degradation products present in the macerated oil.

An attempt to prevent this degradation consists in the addition of substances which prevent the oxidation of cannabidiol: generally, the most common oil-soluble antioxidants such as, for example, vitamin E, are used. The addition of preservative substances gives rise to a potential difficulty in the further formulation steps, in addition to “dirtying” the chemical quality of a natural product that is highly in vogue in the current healthcare market. Furthermore, the introduction of antioxidants into CBD macerated oils seems not to have a direct effect on the oxidation kinetics of the molecule, but rather one on the stability of the oil carrier.

Thus, there is a felt need to be able to obtain CBD solutions in oil that are more stable without the addition of antioxidants.

### SUMMARY

The task of the present invention is thus to provide a process for stabilizing a macerated oil which allows the drawbacks in the prior art to be overcome, without the addition of further substances that are not necessary for the activity of the cannabinoid.

Within the scope this technical task, one aim of the present invention is to provide a process for rendering solutions in oil containing cannabinoids more stable over time.

Another aim of the present invention is to provide a process for stabilizing a macerated oil which improves the quality and shelf-life of pharmaceutical preparations based on solutions in oil containing cannabinoids.

Yet a further aim of the present invention is to provide a process for stabilizing a macerated oil which is simple but safe at the same time.

These and other aims of the present invention are achieved through the realization of a process for stabilizing a macerated oil comprising a liquid carrier and a compound soluble in said carrier and containing at least one cannabinoid, characterized in that it brings about a removal of oxygen from the liquid carrier before or during or after the dissolution of the soluble compound.

Preferably, the process for stabilizing a macerated oil comprises, before the step of removing oxygen, a step of introducing said liquid carrier into a containment device and, subsequently, the step of removing oxygen by creating a vacuum inside the containment device until removing the oxygen present both in the containment device and within the liquid carrier.

Preferably, the containment device comprises a temperature-controlled hermetically sealed reactor or a rotary evaporator.

Preferably, the vacuum is lower than 400 mbar.

Preferably, the controlled temperature is between 12° C. and 200° C. The controlled temperature is preferably between 30° C. and 40° C.

Advantageously, the process measures the oxygen present in the headspace of the containment device above the free surface of the liquid carrier, said measurement being indirectly correlated also with the oxygen dissolved in the liquid.

In particular, the process comprises mechanically stirring said liquid carrier contained in said containment device to dissolve said cannabinoid in the liquid carrier and facilitate the release of oxygen from the liquid carrier.

More in particular, the process comprises performing, after the step of creating a vacuum, a step of blowing and extracting an inert gas into/from the containment device to remove residual oxygen contained in the liquid carrier.

Advantageously, the process cyclically repeats said steps of creating a vacuum and of blowing and extracting an inert gas into/from the containment device until the oxygen measured is equal to zero or no greater than a minimum defined level.

Preferably, the stabilized macerated oil is filled by gravity into hermetic containers prefilled with inert gas until partially or completely replacing the latter.

Preferably, the inert gas comprises nitrogen, and/or a noble gas.

Preferably, the cannabinoid is pure cannabidiol (CBD) obtained by extraction, fermentation, synthesis or semi-synthesis or an extract deriving from Cannabis Sativa L. Preferably, the liquid carrier comprises MCT oil.

### BRIEF DESCRIPTION OF THE DRAWINGS

Further characteristics and advantages of the invention will become more apparent from the description of some preferred, but not exclusive embodiments of the process for stabilizing a macerated oil illustrated by way of non-limiting example in the attached drawings, of which:

FIG. 1: it shows a visual analysis of the CBD solutions in oil as described in Table 1 after stress tests at 100° C. for 3 weeks; in the left part of FIG. 1, one can observe the color changes in the non-inertised macerated oils, at various concentrations of CBD, and on the right the inertised batches, which do not show the same color change as the analogous non-inertised ones.

FIG. 2: it shows a quantification of the variation in the CBD concentration (batch CO1 in Table 1) at time 0, after 1 day, 3 days, 5 days, 10 days and 21 days, during the stress test study with storage at 100° C. for 3 weeks.

FIG. 3: it shows a quantification of the variation in the CBD concentration (batch CO2 in Table 1) at time 0, after 1 day, 3 days, 5 days, 10 days and 21 days, during the stress test study with storage at 100° C. for 3 weeks.

FIG. 4: it shows a quantification of the variation in the CBD concentration (batch C05 in Table 1) at time 0, after 1 day, 3 days, 5 days, 10 days and 21 days, during the stress test study with storage at 100° C. for 3 weeks.

FIG. 5: it shows a quantification of the variation in the CBD concentration (batch C10 in Table 1) at time 0, after 1 day, 3 days, 5 days, 10 days and 21 days, during the stress test study with storage at 100° C. for 3 weeks.

FIG. 6: it shows a quantification of the variation in the CBD concentration (batch C20 in Table 1) at time 0, after 1 day, 3 days, 5 days, 10 days and 21 days, during the stress test study with storage at 100° C. for 3 weeks.

FIG. 7: it shows a quantification of the variation in the CBD concentration (batch C40 in Table 1) at time 0, after 1 day, 3 days, 5 days, 10 days and 21 days, during the stress test study with storage at 100° C. for 3 weeks.

### DETAILED DESCRIPTION

The present invention relates to a process for stabilizing a macerated oil comprising a liquid carrier and a compound soluble in said carrier and containing at least one cannabinoid, characterized in that it brings about a removal of oxygen from the liquid carrier before or during or after the dissolution of the soluble compound.

Macerated oil is understood to mean a solution of a cannabinoid dissolved in oil or a solution of a cannabis extract dissolved in oil.

In particular, according to a preferred embodiment of the invention, the liquid carrier comprises MCT oil, since, as already explained above, it is an oil that is very stable towards oxidation and thus an ideal carrier for the preparation of cannabinoid solutions.

According to a preferred embodiment of the invention, the cannabinoid is in particular cannabidiol (CBD).

The CBD according to the present invention can be purified or a Cannabis sativa L. extract.

The process according to the present invention comprises a step of introducing the liquid carrier into a containment device, and a step of creating a vacuum therein to eliminate the oxygen present in the headspace of the containment device above the free surface of the liquid carrier and within the latter.

According to a first embodiment of the present invention, the containment device comprises a temperature-controlled hermetically sealed reactor.

According to another embodiment of the present invention, the containment device instead comprises a rotary evaporator.

The vacuum to be applied must be lower than atmospheric pressure. In particular, according to a preferred embodiment of the invention, the vacuum is lower than 400 mbar.

The temperature must be between the freezing temperature of the oil and the smoke point thereof.

In particular, the temperature is between 12° C. and 200° C., preferably between 30° C. and 40° C. The vacuum condition specified above makes it possible to eliminate air from the reactor or evaporator, thus facilitating the release of the air dissolved in the liquid carrier (MCT oil) by diffusion.

In particular, the containment device has a probe capable of measuring the presence of oxygen in the headspace of the reactor above the free surface of the liquid carrier.

Furthermore, thanks to the presence of a stirrer inside the containment device, the process allows the liquid carrier contained in the reactor to be stirred mechanically to facilitate the dissolution of the cannabinoid in the liquid carrier (if the inertization takes place during the process of dissolution of the cannabinoid), and to facilitate the release of oxygen from the MCT oil.

Advantageously, the process according to the present invention comprises performing, after the step of creating a vacuum, a step of blowing and extracting an inert gas into/from the reactor or evaporator to remove residual oxygen contained in the liquid carrier.

In fact, after a vacuum has been created in the reactor, the pressure is brought to values close to atmospheric ones by blowing in the inert gas, which is devoid of oxygen.

Advantageously the process cyclically repeats the steps of creating a vacuum and of blowing/extracting the inert gas into/from the reactor or evaporator until the oxygen measured is equal to zero or no greater than a minimum defined level.

According to a first embodiment of the invention, the stabilization process can be carried out directly on the MCT oil before the pure CBD or Cannabis sativa extract is dissolved in it.

In accordance with a second embodiment of the invention, the stabilization process can be carried out during the dissolution of the pure CBD or the Cannabis sativa extract in MCT oil.

According to a third embodiment of the invention, the stabilization process can be carried out after the dissolution of the pure CBD or Cannabis sativa extract in MCT oil.

Once the macerated oil is stabilized, it is filled by gravity into hermetic containers that have also been prefilled with the inert gas until partially or completely replacing the inert gas.

According to a preferred embodiment of the present invention, the inert gas comprises nitrogen but, according to other embodiments, it can also comprise a noble gas.

### Material and Methods

### Stress Test

With the aim of demonstrating the effectiveness of the process of stabilizing CBD when placed in an oily solution, the results of several stress tests performed on CBD solutions at different concentrations, and which measure the effectiveness of the stabilization process under extreme conditions, are reported below. The CBD solutions in oil prepared with the stabilization process of the present invention are compared with the same solutions preparate without the stabilization process and subjected to the same stress tests. It was decided to use MCT oil and not other types of vegetable oils because, as already described previously, it shows to be resistant to oxidation.

The stress test was performed by placing the CBD solutions, indicated in Table 1, in hermetically sealed glass test tubes at 100° C. for 3 weeks; the CBD concentration was measured at time 0, after 1 day, 3 days, 5 days, 10 days and 21 days.

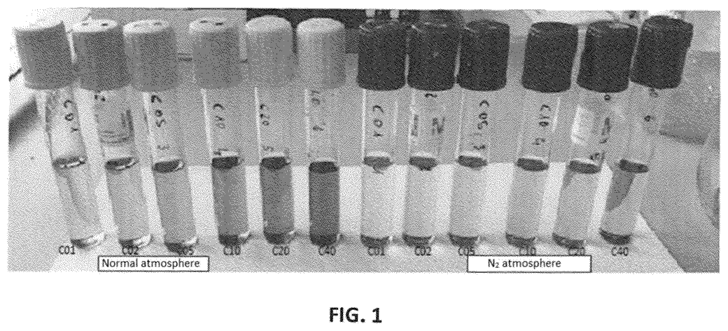

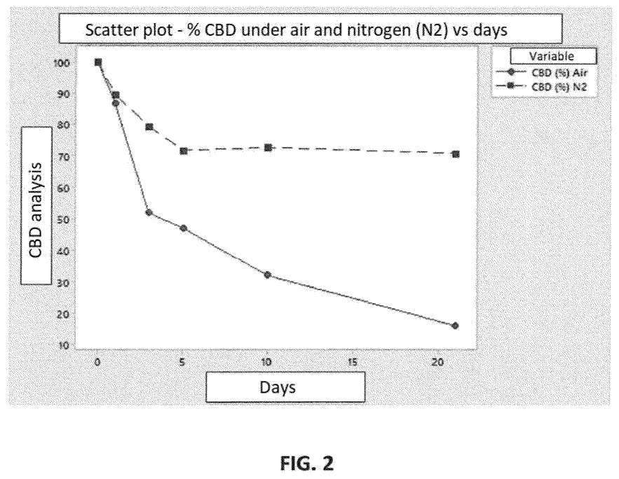

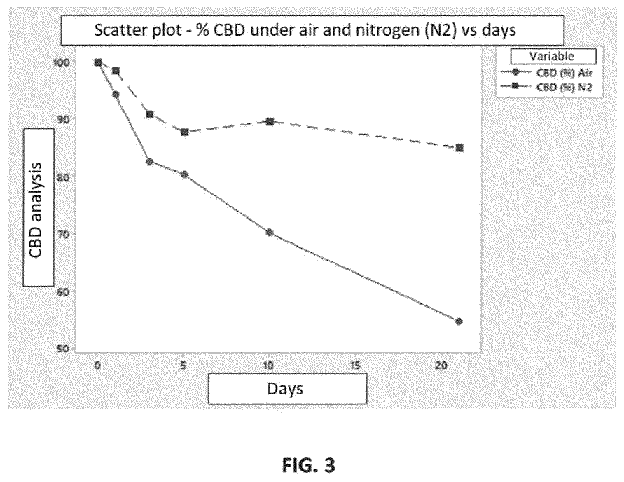

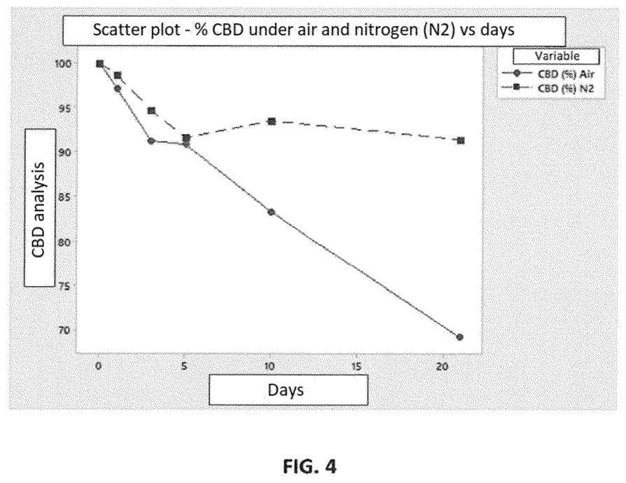

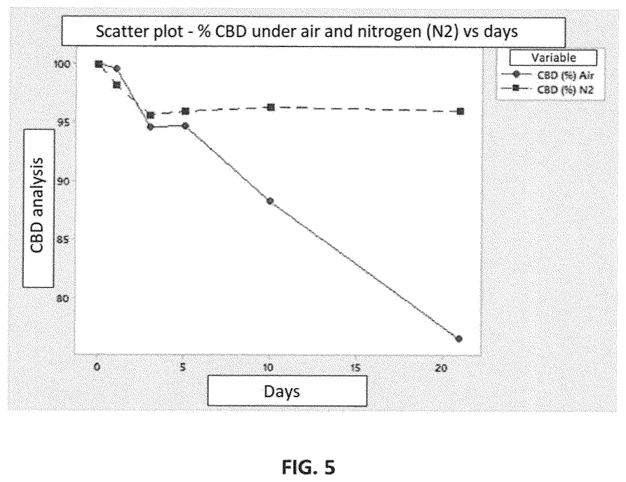

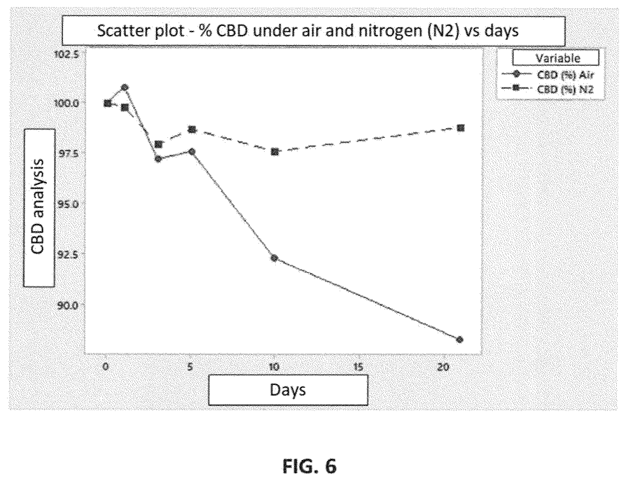

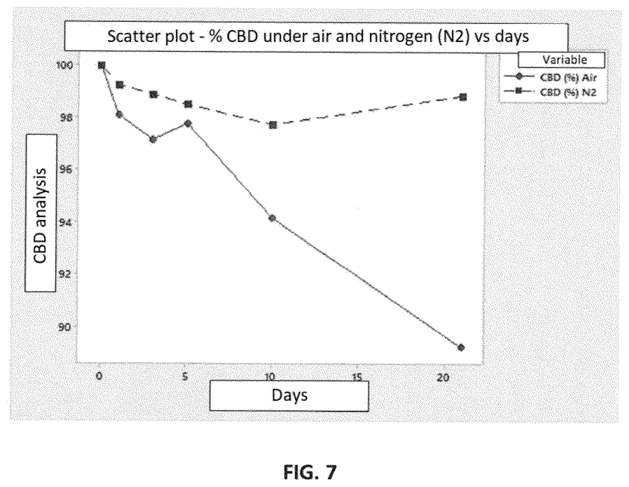

The analysis of the decrease in the CBD concentration (FIGS. 1 to 7) demonstrates that the solutions in contact with atmospheric oxygen undergo continuous degradation, whereas in the ones with an inert atmosphere (i.e. treated with the method of the present invention) an initial degradation is measured, which then stops: this initial deterioration is presumably due to the consumption of traces of oxygen present in the solutions and stops upon the depletion thereof. Table 1 below shows the batches used for the stress test:

TABLE 1

| | | CBD | |
|---|---|---|---|
| | | concentration | |
| Code | Batch | (%) | Manufacturer |
| CBD* | CBD 76718009 | 99.8 | LINNEA |
| Medium-chain | MCT 1223 | n.a. | Gattefossé |
| triglycerides | | | |
| MCTs* | | | |
| C40 | C40 6342 | 40.13 | LINNEA |
| C20 | C20 6342 | 20.64 | LINNEA |
| C10 | C10 6342 | 10.44 | LINNEA |
| C05 | C05 6342 | 5.22 | LINNEA |
| C02 | C02 6342 | 2.58 | LINNEA |
| C01 | C01 6342 | 1.06 | LINNEA |

*MCT and CBD: they refer to the batches used to prepare the CBD solutions.

Table 1: description of batches used for the stress test. The stress test was performed in duplicated (inertized and non-inertized macerated oils) at 100° C. for 3 weeks.

The studies performed with the high-temperature stress test revealed that the same macerated oil undergoes a different process of degradation depending on whether or not oxygen is present within it.

### Stability Under Normal Usage Conditions

In order to demonstrate that the macerated oil stabilization process does not occur only at high temperatures, stability tests were performed on a 10% CBD solution in MCT oil; the first solution was prepared without using the stabilization process described in the present invention (Table 2), whereas the second solution was prepared using the stabilization process according to the present invention (Table 3). Both solutions were placed in climate chambers at 25° C. and 60% humidity for 36 months. Tables 2 and 3 below show the results of the analyses performed during the stability tests.

Table 2 below: stability study on a solution of CBD in MCT oil with a concentration of 10%, prepared without the inertization step described in this patent, placed in climate chambers at 25° C. and 60% humidity for 36 months and analyzed at regular intervals.

TABLE 2

| | Period of analysis (months) | | | | | | | |
|---|---|---|---|---|---|---|---|---|
| Test | 0 | 3 | 6 | 9 | 12 | 18 | 24 | 36 |
| Appearance | Conforms | Conforms | Conforms | Conforms | Conforms | Conforms | Conforms | Conforns |
| Colour (abs | 0.160 | 0.236 | 0.458 | 0.671 | 0.841 | 1.29 | 1.582 | 2.293 |
| at 410 nm) | | | | | | | | |
| HPLC | 102 | 102 | 100 | 101 | 100 | 106 | 105 | 104 |
| concentra- | mg/ml | mg/ml | mg/ml | mg/ml | mg/ml | mg/ml | mg/ml | mg/ml |
| tion: CBD | | | | | | | | |
| Δ⁹-THC | <0.05% | <0.05% | <0.05% | <0.05% | <0.05% | <0.05% | <0.05% | <0.05% |
| CBDV | 0.38% | 0.37% | 0.35% | 0.38% | 0.36% | 0.38% | 0.37% | 0.39% |
| CBD-C4 | 0.15% | 0.14% | 0.14% | 0.15% | 0.15% | 0.15% | 0.16% | 0.15% |
| CBD-HQ | <0.05% | <0.05% | <0.05% | <0.05% | <0.05% | 0.06% | 0.08% | 0.18% |
| Other | <0.05% | <0.05% | <0.05% | 0.07% | 0.13% | 0.12% | 0.14% | 0.07% |
| related | | | | | | 0.05% | 0.07% | |
| substances | | | | | | | | |
| (each) | | | | | | | | |
| Sum of | 0.6% | 0.5% | 0.5% | 0.6% | 0.7% | 0.8% | 0.9% | 0.8% |
| related | | | | | | | | |
| substances | | | | | | | | |

Table 3 below: stability study on a solution of CBD in MCT oil with a concentration of 10%, prepared with the inertization step described in this patent, placed in climate chambers at 25° C. and 60% humidity for 36 months and analyzed at regular intervals.

TABLE 3

| | Period of analysis (months) | | | | | | | |
|---|---|---|---|---|---|---|---|---|
| Test | 0 | 3 | 6 | 9 | 12 | 18 | 24 | 36 |
| Appearance | Conforms | Conforms | Conforms | Conforms | Conforms | Conforms | Conforms | Conforms |
| Colour (abs at | 0.3788 | 0.2198 | 0.4825 | 0.4778 | 0.4188 | 0.4549 | 0.4484 | 0.5048 |
| 410 nm) | | | | | | | | |
| HPLC | 100.4 | 99.4 | 97.9 | 99.1 | 97.7 | 97.6 | 99.1% | 99.6% |
| concentration: | | | | | | | | |
| CBD | | | | | | | | |
| Δ⁹-THC | <0.05% | <0.05% | <0.05% | <0.05% | <0.05% | <0.05% | <0.05% | <0.05% |
| CBDV | 0.30% | 0.30% | 0.32% | 0.30% | 0.29% | 0.30% | 0.30% | 0.30% |
| CBD-C4 | 0.16% | 0.16% | 0.17% | 0.16% | 0.16% | 0.16% | 0.16% | 0.20% |
| CBD-HQ | <0.05% | <0.05% | <0.05% | <0.05% | <0,05% | <0.05% | <0.05% | <0.05% |
| Other related | <0.05% | <0.05% | <0.05% | <0.05% | <0.05% | <0.05% | <0.05% | <0.05% |
| substances | | | | | | | | |
| (each) | | | | | | | | |
| Sum of related | 0.5% | 0.5% | 0.5% | 0.5% | 0.5% | 0.5% | 0.5% | 0.5% |
| substances | | | | | | | | |

Table 2 shows that starting from the test performed at 9 months there was the formation of a new impurity. The subsequent tests showed further impurities which revealed the instability of the solution. Table 3, by contrast, demonstrates that the use of the inertization process renders the solution stable without the formation of new impurities up to the last time of testing.

The great effectiveness of the stabilization process of the present invention in eliminating oxygen from the solutions of CBD in MCT oil was thus demonstrated. Oxygen is in fact the main cause of oxidation of CBD solutions in oil.

The elimination of oxygen thanks to the process of the invention in fact makes it possible to limit the formation of degradation products which cause oxidation of the solutions, thereby improving quality and stability over time and avoiding the formation of contaminating substances that are potentially hazardous to health.

Reported below is a comparative study attesting to the surprising effect of applying a vacuum lower than 400 mbar to remove the oxygen responsible for the degradation of cannabinoids: the elimination of oxygen in these ways, as will be demonstrated, enables the shelf life of macerated oils to be extended considerably.

### Comparative Study

Evaluation of the inertization process at different pressure values: lower than 400 mbar, 400 mbar and higher than 400 mbar, and respective thermal stress tests on the 20% CBD solutions in MCT oil.

The inertization process related to the preparation of macerated oils with cannabis extracts is based on the elimination of oxygen from the macerated oil; this operation is achieved by carrying out vacuum cycles allowing oxygen to be stripped from the oil, followed by pressurization of the receptacle containing the macerated oil with an inert gas, generally nitrogen. Pressurization with the inert gas enables the saturation of the macerated oil, making the dissolution of any oxygen that should come into contact with it more difficult.

The process of removing oxygen has a stabilizing effect on the solution, and in particular on the cannabinoids present therein, by avoiding oxidation reactions.

This report highlights the results of a trial which has the aim of demonstrating the technical effect that is obtained using a pressure lower than, equal to or higher than 400 mbar during the vacuum step of the aforesaid cycles. In particular, as for pressures higher than 400 mbar, the stabilization of the macerated oil has a lesser effect, since the amount of oxygen removed is not sufficient. In order to demonstrate the difference in stability, thermal stress tests are performed on the 20% CBD solutions in MCT oil prepared with vacuum and pressurization cycles carried out at values lower than, equal to or higher than 400 mbar.

In particular, the following 4 tests are performed.
Test No. 1: it refers to the inertization process carried out by depressurizing the solution to the maximum value possible;
Test No. 2: it refers to the inertization process carried out by depressurizing the solution to a value of 400 mbar;
Test No. 3: it refers to the inertization process carried out by depressurizing the solution to a value of 800 mbar; and
Test No. 4: it refers to the preparation of the solution without the vacuum and inert gas pressurization cycles.

Table 4 shows the conditions used for the preparation and inertization of the macerated oil; the other operating conditions not shown in the table were maintained identical for all four tests.

TABLE 4

| | | | Pressure | CBD |
|---|---|---|---|---|
| | | | reached | dissolution |
| | No. of | Vacuum | w/nitrogen | temperature |
| | Cycles | (minutes) | (mbar) | (° C.) |
| Test No. 1 | | | | |
| Vacuum | 1 | 10 | 24 | 38 |
| Pressurisation | | 5 | 800 | |
| Vacuum | 2 | 10 | 40 | |
| Pressurisation | | 5 | 800 | |
| Vacuum | 3 | 10 | 14 | |
| Pressurisation | | 5 | 800 | |
| Vacuum | 4 | 10 | 20 | |
| Pressurisation | | 5 | 800 | |
| Vacuum | 5 | 10 | 20 | |
| Pressurisation | | 5 | Atmospheric | |
| | | | pressure | |
| Test No. 2 | | | | |
| Vacuum | 1 | 10 | 400 | 38 |
| Pressurisation | | 5 | 800 | |
| Vacuum | 2 | 10 | 400 | |
| Pressurisation | | 5 | 800 | |
| Vacuum | 3 | 10 | 400 | |
| Pressurisation | | 5 | 800 | |
| Vacuum | 4 | 10 | 400 | |
| Pressurisation | | 5 | 800 | |
| Vacuum | 5 | 10 | 400 | |
| Pressurisation | | 5 | Atmospheric | |
| | | | pressure | |
| Test No. 3 | | | | |
| Vacuum | 1 | 10 | 800 | 38 |
| Pressurisation | | 5 | 900 | |
| Vacuum | 2 | 10 | 800 | |
| Pressurisation | | 5 | 900 | |
| Vacuum | 3 | 10 | 800 | |
| Pressurisation | | 5 | 900 | |
| Vacuum | 4 | 10 | 800 | |
| Pressurisation | | 5 | 900 | |
| Vacuum | 5 | 10 | 800 | |
| Pressurisation | | 5 | Atmospheric | |
| | | | pressure | |
| TEST No. 4 | None | None | Atmospheric | 38 |
| | | | pressure | |

The solutions relating to the 4 tests are kept at 120° C. for a total of 4 days, with samples being drawn at regular intervals of 1, 4, 8, 24 and 96 hours. All the samples are analyzed by HPLC analysis to assess the profile of impurities at every time point, and the CBD concentration for the time points of 24 hours and 96 hours as well as for the initial point before the thermal stress.

The results of the test are shown in Tables 5a-5b.

TABLE 5a

| | test 1 | | | | | | test 2 | | | | | |
|---|---|---|---|---|---|---|---|---|---|---|---|---|
| Impurity | T0 | 1 h | 4 h | 8 h | 24 h | 96 h | T0 | 1 h | 4 h | 8 h | 24 h | 96 h |
| 1 | | | | | | | | | | | | |
| 2 | | | | | | | | | | | | |
| 3 | | | | | | | | | | | | |
| 4 | | | | | | | | | | | | |
| 5 | | | | | | | | | | | | 0.02 |
| 6 | | | | | 0.02 | 0.09 | | | | 0.01 | 0.02 | 0.15 |
| 7 | | | | | | 0.03 | | | | | | 0.08 |
| 8 | 0.02 | 0.03 | 0.02 | 0.02 | 0.02 | 0.02 | 0.02 | 0.02 | 0.03 | 0.03 | 0.02 | 0.01 |
| 9 | | | | | | | | | | | | |
| 10 | | | | | | 0.01 | | | | | | 0.03 |
| 11 | | | | | | | | | | | | 0.02 |
| 12 | | | | | | | | | | | | |
| 13 | | | | | | | | | | | | 0.01 |
| 14 | 0.05 | 0.05 | 0.05 | 0.05 | 0.05 | 0.07 | 0.05 | 0.05 | 0.05 | 0.05 | 0.05 | 0.07 |
| 15 | | | | | | | | | | | | |
| 16 | | | | | | 0.02 | | | | | | 0.04 |
| 17 | | | | | | 0.01 | | | | | | 0.02 |
| 18 | | | | | | 0.03 | | | | | | 0.04 |
| 19 | | | | | 0.02 | 0.07 | | | | | 0.01 | 0.17 |
| CBD | 20.51 | | | | 20.53 | 20.24 | 20.49 | | | | 20.48 | 19.7 |
| 21 | | | | | | | | | | | | |
| 22 | | | | | 0.01 | 0.04 | | | | | 0.01 | 0.1 |
| 23 | | | | | | | | | | | | |
| 24 | | | | | | 0.03 | | | | | | 0.02 |

TABLE 5b

| | test 3 | | | | | | test 4 | | | | | |
|---|---|---|---|---|---|---|---|---|---|---|---|---|
| Impurity | T0 | 1 h | 4 h | 8 h | 24 h | 96 h | T0 | 1 h | 4 h | 8 h | 24 h | 96 h |
| 1 | | | | | | | | | | | | 0.01 |
| 2 | | | | | | | | | | | | 0.01 |
| 3 | | | | | | | | | | | | 0.02 |
| 4 | | | | | | | | | | | | 0.04 |
| 5 | | | | | | 0.02 | | | | | 0.01 | 0.08 |
| 6 | | | | 0.01 | 0.02 | 0.16 | | 0.02 | 0.04 | 0.08 | 0.14 | 0.61 |
| 7 | | | | | | 0.08 | | | | 0.02 | 0.05 | 0.27 |
| 8 | 0.02 | 0.02 | 0.03 | 0.03 | 0.02 | | 0.02 | 0.03 | 0.02 | 0.02 | 0.02 | |
| 9 | | | | | | | | | | | | 0.04 |
| 10 | | | | | | 0.03 | | | | 0.01 | 0.02 | 0.09 |
| 11 | | | | | | 0.02 | | | | | 0.01 | 0.06 |
| 12 | | | | | | | | | | | | 0.01 |
| 13 | | | | | | 0.01 | | | | | | 0.05 |
| 14 | 0.05 | 0.05 | 0.05 | 0.05 | 0.05 | 0.07 | 0.05 | 0.05 | 0.05 | 0.05 | 0.05 | 0.06 |
| 15 | | | | | | | | | | | | 0.02 |
| 16 | | | | | | 0.04 | | | | 0.01 | 0.03 | 0.14 |
| 17 | | | | | | 0.02 | | | | | | 0.02 |
| 18 | | | | | | 0.04 | | | | 0.01 | 0.02 | 0.07 |
| 19 | | | | | 0.01 | 0.2 | | | 0.02 | 0.06 | 0.17 | 0.99 |
| CBD | 20.55 | | | | 20.36 | 19.68 | 20.51 | | | | 19.55 | 15.95 |
| 21 | | | | | | | | | | | | 0.02 |
| 22 | | | | | 0.01 | 0.1 | | | 0.01 | 0.03 | 0.09 | 0.4 |
| 23 | | | | | | | | | | | | 0.01 |
| 24 | | | | | | 0.02 | | | | | | |

At the time of preparation of the four solutions for the 4 tests, the HPLC analyses (see columns TO in Tables 2a-2b) show that besides the CBD, only impurities 8 and 14 are present. These impurities are present at all the time points and their concentration does not change, indicating that they are neither degraded nor increase in concentration during the thermal stress.

However, one notes the formation of new impurities whose concentration increases with increases in time.

As regards the CBD concentration, one observes a degradation over time, which becomes more marked depending on the type of inertization test.

Before the start of the thermal stress of the 4 solutions (TO), the CBD concentration is nearly identical for the 4 tests; after 24 and 96 hours, degradation is increasingly evident, but is directly correlated with the inertization procedure carried out in the 4 tests.

In particular, Test 1 shows the least degradation, probably due to the sole thermal effect (120° C.), whereas the result of test 4 is the worst.

The results of inertization carried out with vacuum cycles higher than or equal to 400 mbar (test 3 and test 2, respectively) are also much worse compared to test 1 (after 96 hours the CBD concentration decreased by 1.3% in test 1, 3.9% in test 2, 4.2% in test 3 and 22.2% in test 4).

The degradation of the CBD is not the only effect observable during the thermal degradation, as many impurities form, also at a non-negligible concentration.

The degradation increases over time but is directly correlated with the type of inertization test; test 1 generates more stable solutions compared to the tests performed without inertization or with partial inertization (vacuum higher than or equal to 400 mbar).

### Conclusions of the Comparative Study

The degradation of cannabinoids in oil solutions, in particular of CBD in MCT oil, depends on the oxygen dissolved in the oil. The elimination of this oxygen makes it possible to render cannabinoid solutions much more stable towards degradation and to increase their shelf life.

The four tests performed demonstrate that the degradation of solutions depends on the amount of oxygen remaining inside the solution and in particular that vacuum values lower than 400 mbar can enable the almost total elimination of oxygen.

The final target to be reached is thus the total elimination of dissolved oxygen.

It was decided to use 20% CBD solutions in order to have a simple matrix to study with few interferences due to other cannabinoids or other components of more complex matrices.

The process for stabilizing a macerated oil thus conceived is susceptible of numerous modifications and variants, all falling within the scope of the inventive concept as disclosed and claimed.

1. A process for stabilizing a liquid carrier in combination with a compound soluble in said liquid carrier and containing at least one cannabinoid, wherein oxygen is removed from the liquid carrier before or during or after the dissolution of the soluble compound, and wherein before the step of removing oxygen, a step of introducing said liquid carrier into a containment device and, subsequently, removing oxygen by creating a vacuum lower than 400 mbar inside the containment device until the oxygen present both in the containment device and inside the liquid carrier is removed.

2. The process for stabilizing the liquid carrier in combination with the soluble compound according to the preceding claim 1, wherein said containment device comprises a temperature-controlled hermetically sealed reactor or a rotary evaporator.

3. The process for stabilizing the liquid carrier in combination with the soluble compound according to claim 2, wherein said controlled temperature is between 12° C. and 200° C.

4. The process for stabilizing the liquid carrier in combination with the soluble compound according to claim 3, wherein said controlled temperature is between 30° C. and 40° C.

5. The process for stabilizing the liquid carrier in combination with the soluble compound according to claim 1, wherein the oxygen present in the headspace of the containment device above the free surface of the liquid carrier is measured, said measurement being indirectly correlated also with the oxygen dissolved in the liquid.

6. The process for stabilizing the liquid carrier in combination with the soluble compound according to claim 1, wherein said liquid carrier contained in said containment device is mechanically stirred to facilitate the release of oxygen from the liquid and to allow the dissolution of said cannabinoid in said liquid carrier if the inertization takes place during the dissolution of the cannabinoid in the liquid carrier.

7. The process for stabilizing the liquid carrier in combination with the soluble compound according to claim 1, wherein after the step of creating a vacuum, a step of blowing and extraction of an inert gas into/from the containment device is carried out to remove the residual oxygen contained in the liquid carrier.

8. The process for stabilizing the liquid carrier in combination with the soluble compound according to claim 1, wherein said steps of creating a vacuum and of blowing/extracting the inert gas in the containment device are carried out until the oxygen measured is equal to zero or no greater than a minimum defined level.

9. The process for stabilizing the liquid carrier in combination with the soluble compound according to claim 1, wherein the liquid carrier in combination with the stabilized soluble compound is filled by gravity into hermetic containers prefilled with inert gas until partially or completely replacing the latter.

10. The process stabilizing the liquid carrier in combination with the soluble compound according to claim 1, wherein said inert gas comprises nitrogen, and/or a noble gas.

11. The process for stabilizing the liquid carrier in combination with the soluble compound according to claim 1, wherein said cannabinoid is pure cannabidiol (CBD) obtained by extraction, fermentation, synthesis or semi-synthesis or a Cannabis sativa extract.

12. The process for stabilizing the liquid carrier in combination with the soluble compound according to claim 1, wherein said liquid carrier comprises MCT oil.
